(19) United States
(12) Patent Application Publication
(10) Pub. No.: US 2005/0144102 A1
(43) Pub. Date: Jun. 30, 2005

(54) Market visualisation tool

(76) Inventor: Oliver Ashby Johnson, London (GB)

Correspondence Address: HARNESS, DICKEY & PIERCE, P.L.C., P.O. BOX 828, BLOOMFIELD HILLS, MI, 48303, US

(21) Appl. No.: 10/769,343

(22) Filed: Jan. 30, 2004

(30) Foreign Application Priority Data
Dec. 30, 2003 (GB) GB 0030162.9

(51) Int. Cl. G06F 17/60

(52) U.S. Cl. 705/35

(57) ABSTRACT

There is disclosed a visual display comprising: a plurality of value indicators, indicating values for a plurality of market measures, said plurality of value indicators extending over a plurality of markets; at least one user settable limit value, representing a limit value of a said market indicator; wherein said display is operable for highlighting any individual said market indicators which exhibit a predetermined level of activity.

### FIELD OF THE INVENTION

The present invention relates to the field of computer science, and particularly although not exclusively, to an improved method, apparatus, service and system for visualization of market data and information.

### BACKGROUND TO THE INVENTION

Prior art computerised trading tools for use in financial institutes such as banks, merchant banks, and future exchanges involve screen based solutions for displaying a set of individual bid/offer prices within a particular market. Examples of such systems are common.

For example, the known Bloomberg trading screens present columns of bid/offer prices for trades in a particular market, for example the Euro/US dollar market, such systems are described in International patent application WO 03/08753.

In another example, the known CQG screen based system displays a range of parameters and charts concerning a wide range of individual markets such as the DAX index, or the FTSE 100 index. In the known CQG system, charts showing movement of the whole of a market, such as the DAX index, consisting of all the constituent stocks of that index is displayed on a single screen.

Referring to FIG. 1 herein, there is illustrated schematically a known data service apparatus comprising a service provider computer entity 100, which may be operated by a known service provider entity, for example Bloomberg, Reuters, or a similar organization, which provides a data stream of market data over a range of markets, to a set of customers for a data stream service. The service provider computer communicates with a plurality of market server computers 101-103, each market server computer collecting data from a plurality of sources, such as trading desks within local bourses or financial exchanges. For example, the service provider computer may receive data over a communications network 104 from the Frankfurt exchange, the London stock exchange, the London Futures and Options market, the New York stock exchange, the Chicago Board of Trade Options and Futures market, the London Metal exchange, and a wide range of similar markets, where each market provides data through a corresponding respective market server computer.

A prior art service provider, is capable of providing market data over a range of markets in real time. Such services are well known, and include the known Bloomberg service, and similar services from CQG and other service providers. Real time data is collected from a plurality of individual trading desks, into which users of markets input data describing the bid/offer prices for individual trading instruments, and the actual prices at which bargains are transacted in real time. The service provider 100 may receive data from a wide range of markets, and provide that data as a data stream service to a plurality of subscribers.

The collection and dissemination of market data through technology based systems is well documented in the prior art, for example in WO 00/30007 (chase Manhattan bank); EP 1,004,073 B (to Chase Manhattan bank), GB 2,224,141 B (Reuters), GB 2,161,003 B (Merrill Lynch), and EP 0,407,026 B (Reuters) as an exemplary sample.

Known display systems for traders and analysts provide market data over a wide range of markets, which can be displayed on a set of different screens at a same trading desk. However, the range of data available is vast, and there are many markets throughout the world. Additionally, in each market, there may be more than one measure of that market. For example, the UK stock market has the FTSE 100 index, the FTSE 250 index and the FTSE all share index. Additionally, traders may use other secondary measures such as a three day moving average, nine day moving average and fifteen day moving average of the FTSE 100 index, and similarly for other indices.

Human traders and analysts are always looking for unusual movements in markets, which may represent profitable trading opportunities, however, it is not immediately obvious from the wide range of data available in conventional screen displays which markets are moving in an unusual pattern of behavior, or where there exists a significant amount of activity compared to the normal level of activity. In many financial institutions, every day there is held a morning meeting at which a firm's economist team will brief traders on what they perceive as being the markets in which there will be significant activity in the immediate short term, to give the traders clues as to where trading profits are likely to be made.

Due to the small size of individual trading screens, presenting a large amount of information over a diverse range of individual markets presents a technical problem of condensing the data and information concerning those markets into an abstract summary form which can be presented on a single screen.

Further, it is now common for both amateur traders and professional traders to trade from home or at remote locations over the internet using a single PC or mobile laptop computer. Such devices present only a single screen, and do not have the capacity for many different visual display devices as found on a conventional professional trading desk at a financial institution. Such traders and analysists working remotely over the internet do not have access to multiple screen views.

### SUMMARY OF THE INVENTION

Specific embodiments according to the present invention aim to provide a means by which a human user can visualize levels of activity across a wide range of markets and therefore to enable any significant movements of capital flow from one market to another or between a plurality of markets to be quickly identified.

Specific embodiments herein also aim to provide a human user with a means for comparing a plurality of diverse markets on the basis of a unifying parameter which can be applied individually to each market, and thereby, by making a comparison of individual values for the unifying parameter, a direct relative comparison between a plurality of individual markets can be made.

According to a first aspect there is provided a visual display comprising:
a plurality of market indicators, each indicating a corresponding respective market
a plurality of value indicators, extending over said plurality of markets; indicating values for a plurality of market measures in real time; and
at least one user settable limit value, representing a limit value of a said value indicator; wherein
said display is operable for highlighting any individual said value indicator which exhibits a predetermined level of activity in relation to a said limit value.

According to a second aspect, there is provided an electronic data carrier containing program means for generating a visual display, said program means comprising:
means for generating a plurality of market indicators, each indicating a corresponding respective market;
means for generating a plurality of value indicators extending over a plurality of markets, indicating values for a plurality of market measures in real time;
means for setting at least one user settable limit value representing a limit value of a said value indicator; and
means for generating a highlight display, for highlighting any individual said value indicator under conditions when a value of said market measure exceeds a pre-determined level.

According to a third aspect, there is provided a visual interface comprising:
a plurality of market indicators, representing a plurality of different markets;
said plurality of market indicators being arranged within a single view, such that said plurality of market indicators can be viewed at the same time on a single screen; and
a set of user adjustable limits, operable for setting range limits for said plurality of market indicators;
wherein said interface is operable for automatically highlighting individual said market indicators, when said market indicators reach a pre-determined relationship compared to said range limits.

According to a fourth aspect, there is provided a method of operating a visual interface comprising:
generating a plurality of market indicators representing a plurality of different markets;
arranging said plurality of market indicators within a single view such that said plurality of market indicators can be viewed at the same time on a single display screen;
generating a set of user adjustable limits representing upper and lower limits for each of said plurality market indicators; and
when individual ones of said market indicators exceed said upper or lower limits, automatically highlighting said displayed individual market indicators on said single screen view.

According to a fifth aspect, there is provided a data carrier comprising program means for generating a visual display comprising:
a program component for generating a plurality of market indicators representing a plurality of different markets;
a component for arranging said plurality of market indicators within a single view such that said plurality of market indicators can be viewed at the same time on a single display screen;
a component for generating a set of user adjustable limits representing upper and lower limits for each of said plurality market indicators; and
a component for automatically highlighting individual ones of said market indicators which exceed said upper or lower limits.

According to a sixth aspect, there is provided a data display comprising:
a market indicator region for displaying a set of market indicators describing individual markets;
a market measure display region configured to display in real time a set of values of one or more market measures;
a limit display region for setting upper and lower limits on values of a said market measure;
wherein said display is operable for highlighting any individual market data under conditions where a value of a said market indicator exceeds said upper or lower limit values.

According to a seventh aspect, there is provided a method of displaying data representing a plurality of markets, said method comprising:
displaying in real time a set of values of at least one market measure;
displaying a set of market indicators each describing individual said market;
displaying a limit region comprising upper and lower limit displays representing limits on values of a said at least one market measure;
highlighting any individual market data which has a value which exceeds said upper and lower limit values displayed in said corresponding respective limit region.

According to an eighth aspect there is provided a method of measuring trends in a portfolio of financial interests, said method comprising:
determining an individual “V” normalizing parameter for each market said normalizing parameter being a parameter which is determined from a set of volatility measurements of said market;
determining a representative value for all of the individual normalizing parameters, for each said market;
determining how many of the individual markets comprising the portfolio have a normalizing parameter value above the representative value, these being markets which are leading the trend of all markets in the portfolio;
determining how many of the individual markets have a normalizing parameter value below the representative value, these being markets which are lagging the trend of all markets in the portfolio;
determining and displaying the proportion of the whole portfolio which is leading or lagging the portfolio trend.

According to a ninth aspect, there is provided a method of trading financial interests, said method comprising:
providing via a computer network, a stream of market data representing market measures of a plurality of financial interests;
arranging said plurality of market measures on a visual display device, such that said plurality of market measures appear in a single view;
automatically determining individual ones of said market measures which exhibit relatively greater variations in value compared to other ones of said market measures;
highlighting said market measures which are identified as having a relatively higher movement than said other market measures; and
effecting at least one transaction between a pair of said markets having market measures which exhibit relatively larger movements.

According to a tenth aspect, there is provided a method of determining a normalizing parameter by which a plurality of markets may be compared with each other, said method comprising:
for each said market:
obtaining a backward looking volatility data;
obtaining a forward looking volatility data;
obtaining a current volatility data;
combining said backward looking, forward looking and current volatility data to obtain said normalizing parameter.

Other aspects of the present invention are as described in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a prior art system for routing market data to a service provider;

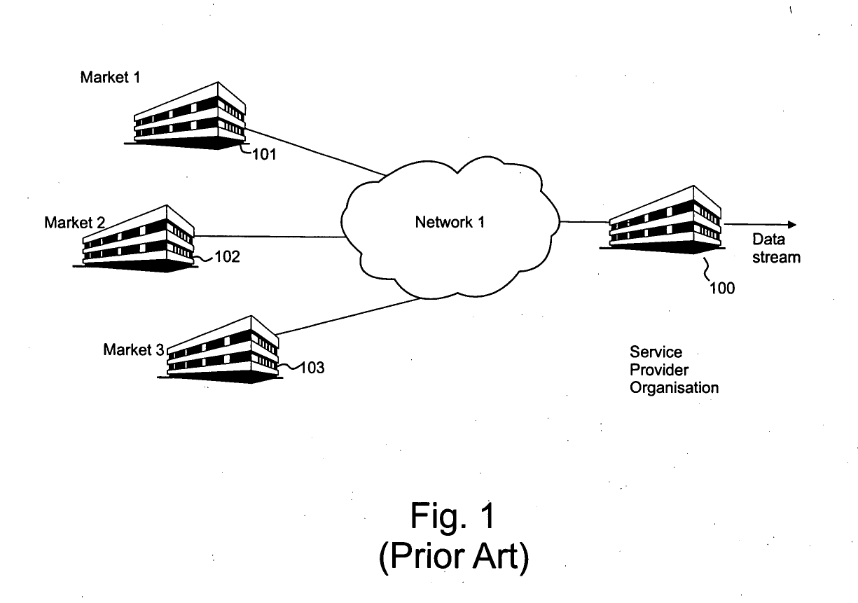

FIG. 2 illustrates schematically a market data service provider entity providing real time market data to a client computer, according to a first specific embodiment of the present invention;

FIG. 3 illustrates schematically a first display and trading system comprising a trading desk containing a visual display interface according to the first specific embodiment of the present invention;

FIG. 4 illustrates schematically connectivity between a market data service provider computer and a client computer installation at a client financial services business, according to the first specific embodiment of the present invention;

FIG. 5 illustrates schematically a second display and trading system comprising a client personal computer receiving real time market data from a market data service provider computer according to a second specific embodiment of the present invention;

FIG. 6 illustrates schematically components of a first data processing and display system according to a third specific embodiment of the present invention;

FIG. 7 illustrates schematically components of a second data provision and display system according to a fourth specific embodiment of the present invention;

FIG. 8 illustrates schematically a first display interface according to a fifth specific embodiment of the present invention;

FIG. 9 illustrates a particular instance of the first display interface of FIG. 8, showing a display of market data;

FIG. 10 illustrates schematically a second instance of the first display interface of FIG. 8, showing a different set of market data;

FIG. 11 shows a second display interface according to a sixth specific embodiment of the present invention;

FIG. 12 illustrates schematically setting of alert levels according to a statistical distribution of a market measure;

FIG. 13 illustrates schematically a data flow diagram for calculation of a “V” parameter according to a first specific method of the present invention; and

FIG. 14 illustrates schematically an overall process for trading financial interests using a display and trading system, according to a second specific method of the present invention.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

In this specification, the term “personal computer” will be taken to include all personal computing devices and devices of a personal nature, including portable devices having screen displays and is not restricted to computers having the PC standard architecture. For example, in this specification the term “personal computer” includes Apple Macintosh computers, laptop computers, palm type computers, and notebook type computers, as well as mobile phone type devices and personal digital assistant devices (PDA's). The term personal computer includes portable personal computers which can connected to the internet remotely via a wireless connection.

In this specification, the term “real time” when used in reference to a data stream provided by a market data service provider computer, means data which changes at intervals which are the data refresh intervals provided by that market data service provider. For example, where a market data service provider provides data which changes on a minute by minute basis, then real time data has a time scale of minutes. Where the service provider provides data which changes on an hourly basis, then real time means data which changes on an hour by hour basis, and likewise for other intervals.

In this specification, the term “real time” when used in reference to a visual display, means a time scale which is short enough such that any changes in a data stream received from a service provider computer are substantially instantaneously translated into changes in values for displayed on a screen view.

In this specification, the term “measure” when referring to a market measure, means any type of measure which can be used to quantify a status of a market. For example a market measure may include an index, for example the FTSE 100 index, the Dow Jones index, or like measure. Measures can also include individual measures for individual financial instruments, for example a bid price or offer price of a financial instrument is an example of a market measure for that particular instrument.

In this specification, the term “market” is used to describe any type of market in which trading or exchange of a commodity, contract or product exists. A market may exist in a single financial instrument, for example an individual class of stock or equity share, or a market may comprise a plurality of individual financial interests, for example a plurality of individual equity shares. The term “market” includes derivative markets, primary markets, secondary markets, gray markets and the like.

In this specification, the term “market data” is used to describe any type of quantitative and/or qualitative data concerning the status of a particular market, and includes the prices of individual contracts, instruments or products which are traded on a market.

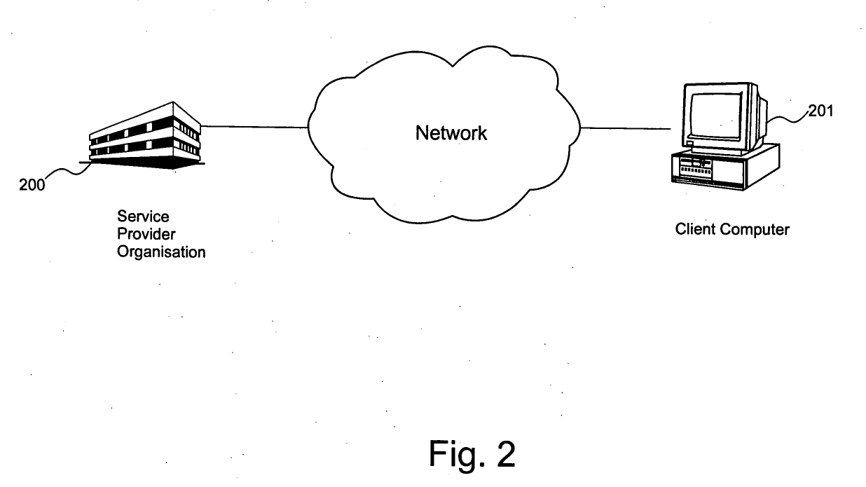

Referring to FIG. 2 herein, there is illustrated schematically at least one service provider computer operated by a service provider organization 200 and at least one client computer 201 according to a first specific embodiment, wherein the service provider computer communicates real time market data over a communications network to the client computer. The communications network may comprise a computer network, a telecommunications network, or a combination of the two.

For ease of illustration thereafter, communication between one service provider computer entity and one client computer will be shown. In practice, each client computer may receive data from one or a plurality of service provider computers, and each service provider computer will make data available to one or a plurality of client computers.

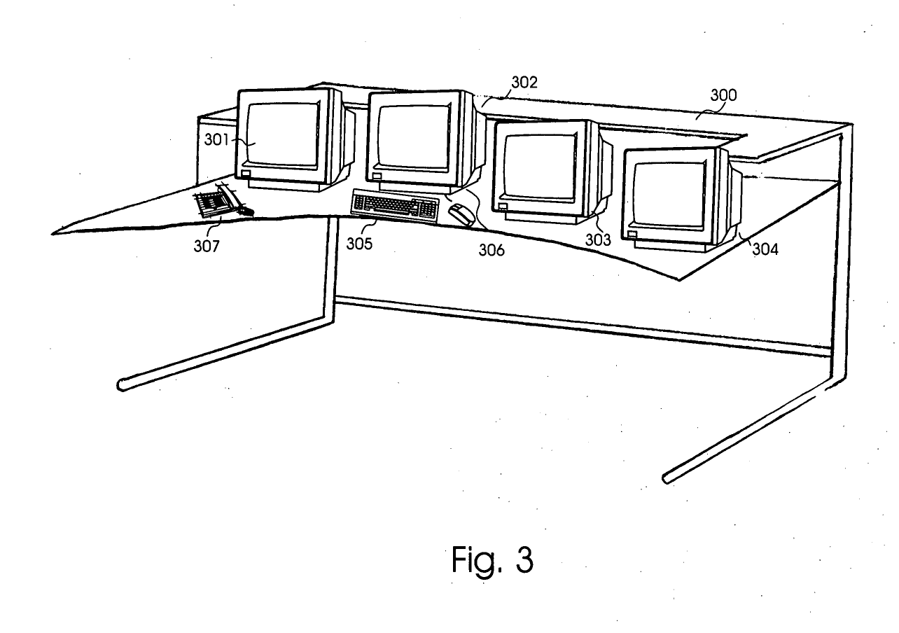

Referring to FIG. 3 herein, there is illustrated schematically one example of components of a trading desk at a client institution, comprising a plurality of visual display devices 301-304, enabling a trader or analyst to view a plurality of individual screen views at once on different visual display devices; at least one data input device, such as a keyboard and/or mouse device 306; and a telephone handset 307. The plurality of visual display devices may display news information and market price values on a range of display devices. For example, one display device may be used for a Reuters news service, another display may be used to display local stock market data, further display may be used for making online trades. Transactions in market can be made either by telephone, or by online trading using the keyboard and mouse interface, and various of the visual display devices connected to the client computer. One or more of the display devices may be configured for providing a screen view displaying a plurality of different markets on a same screen, as described herein according to a specific method of the present invention.

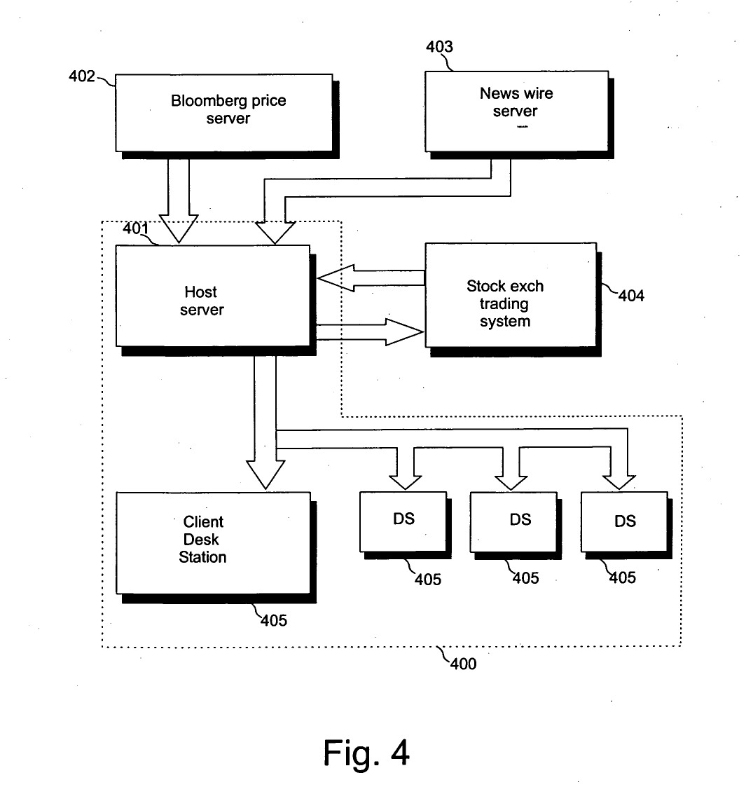

Referring to FIG. 4 herein, within a client financial institution 400, such as a bank, a research house, or a market maker entity or similar institution, there is provided a client host server computer 401, which communicates with a variety of other computer entities operated by other business entities including but not limited to a market data service provider computer 402, for example providing a Bloomberg data service; a news wire server computer 403, for providing a real time news service, for example a Reuters type service; and one or more market or exchange trading system computers 404, for example stock exchange computer systems.

In the example shown, a service provider computer 402 provides a market data service to a client server 401 which receives a real time stream of data from the market data server 402, and additionally data from one or more news wire servers 402 which serve up real time news, for example Reuters news services. The client server connected with a local market trading system computer 404, may enable a trader to effect trades in a particular market, and to enable data describing individual trades that a dealer has made to be collected by the market trading system. The data service provider computer 401 may receives its raw data from many sources, including the market trading system 404.

The client host server 401, which may be resident at a financial institution such as a bank or market maker entity, is connected to a plurality of client desk stations 405. Each client desk station 405 may comprise a plurality of display devices as shown in FIG. 3 herein, including at least one display device configured for presenting a display interface which shows a plurality of markets in a single view, in a manner in which those markets may be directly compared on the basis of a common parameter, and in which significant movements of each individual market may be highlighted on screen in a common single view across all of the markets displayed. The functionality is provided to enable visualization of the plurality of different markets, which can be used as selectable, and a plurality of market measures which n various embodiments can be arranged according to a user selection, in a single screen view.

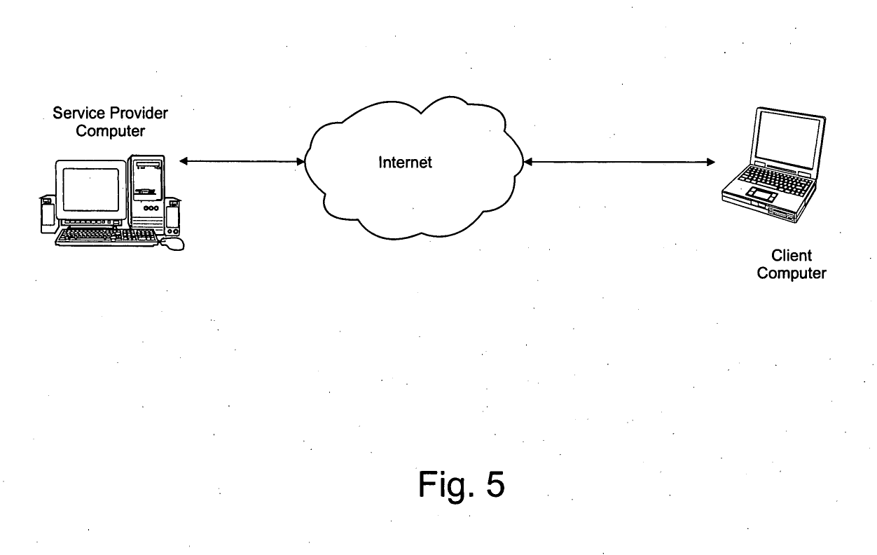

Referring to FIG. 5 herein, there is illustrated schematically, a second specific embodiment of a display and trading system, in which visualisation functionality is provided on a client side computer 500, which receives market data from a service provider server on a service provider side 501 of a network 502. In the second embodiment system, on the service provider side 501 there is provided a conventional wire data service 503 which outputs a real time data stream over a communications network to a client side computer.

On the client side, the real time data stream inputs via a data modem 604 and is input into a visualisation component 505. The visualization component receives input commands from a user interface 506 comprising at least one keyboard device 507 and/or one or more pointing devices 508; and outputs a screen display view 606 which can be displayed on a visual display device of the client side computer 503.

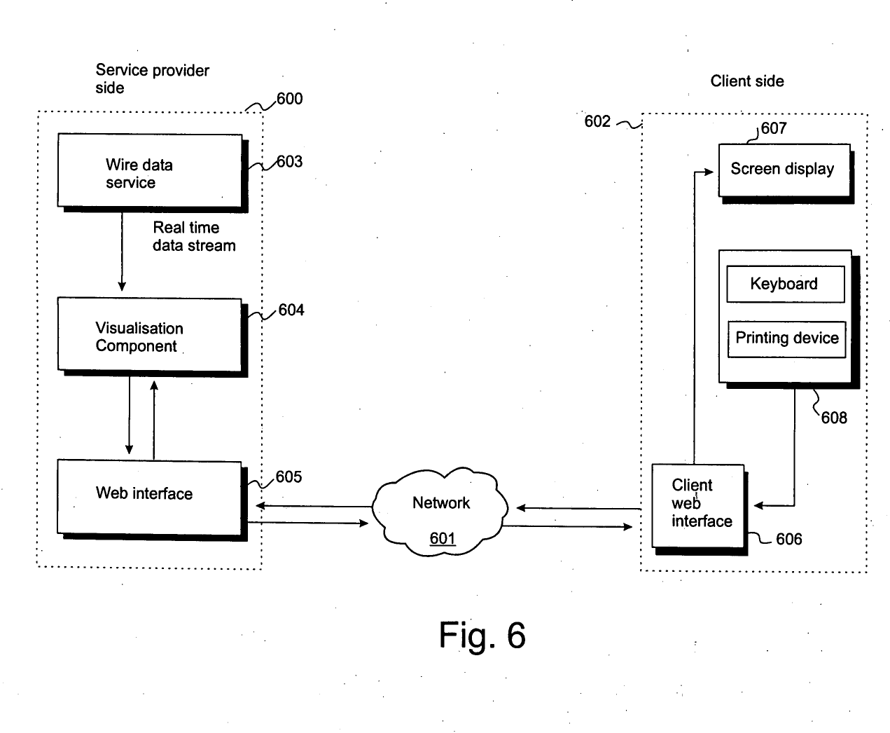

Referring to FIG. 6 herein, there is illustrated schematically one embodiment of a visualization system, in which functionality is provided at the service provider side 600 of a communications network 601, to provide online market data to an organization at a client side 602.

On the service provider side is provided a wire data service 603 which outputs a real time data stream as is known in the prior art; a visualization component 604; and a conventional web interface 605 for communicating across the network 601 with the client side.

On the client side, is provided a web interface 606 for communicating over the network with the service provider side; a screen display component 607 for generating a screen display on a visual display device; and a user interface 608 comprising a keyboard and pointing device, for example a mouse or the like.

Data is provided by the service provider computer as a stream of data having regular refresh updates. The data is real time data, depending upon the level of service provided by the service provider, which means that values of market indicators change substantially in real time. Real time data does not necessarily change on a time scale of less than one second, but it may do. A time scale over which data changes is determined by various delays in the market server computers, from which the service provider computer obtains the data, and in the service provider computer itself. For example, in a market which consists of a trading floor where individual human traders make bargains with each other, the details of such bargains may be written down on slips of paper and then passed to another person who will enter details of the trade into a stock exchange computer system. There may be a delay of seconds or minutes between the time at which the trade is actually made between traders, and the time at which the data is entered into the market computer. Additionally, there may be a further delay whilst the market computer analyses and stores that data, which typically may be in the range of no more than a few seconds, and in many cases of the order of milli-seconds. There may then be a further delay before the service provider computer obtains the data relating to the trade from the market computer. For example, the service provider computer may receive data updates from the market computer every 5, 10, or 15 minutes or every hour, depending upon the communication between the service provider computer and the market computer is structured.

Further, the client computer may receive updates of data from the service provider computer on a time scale which is either substantially continuous, that is, where the service provider and computer and client computer are in constant online communication and any changes in data at the service provider computer are passed on substantially instantaneously (delayed only by the inherent delays in the communications link, which may be of a matter of milliseconds or seconds). Alternatively, where a lower cost level of service is provided, data refreshes from the service provider computer to the client computer may occur every 15 minutes; every hour, or in some circumstances, at the end of each day.

Since the client computer is not restricted to receiving a data stream from a single service provider, for example Bloomberg, but may receive data from a plurality of service provider computers, the client computer may receive different levels of service from each service provider. For example, data may be refreshed every 5 minutes from one service provider computer, whereas data may be refreshed every hour or day from another service provider computer.

Data from any of the service provider computers can be combined into a single screen display at the client computer, and so the market values displayed on a display screen at the client computer can be obtained from a variety of sources, and individual market values may have different rates of update within the same display screen. For example, a FTSE 100 index value may be updated on a minute by minute basis, whereas on the same screen display, a market value of Titanium from the London Metals Exchange may be updated on an hourly basis.

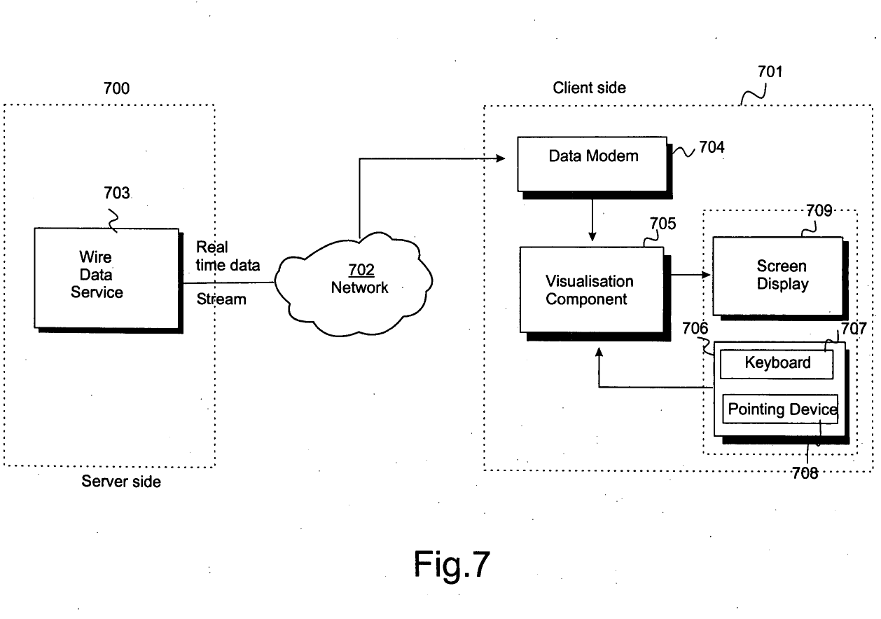

Referring to FIG. 7 herein, there is illustrated schematically a further specific embodiment, in which a service provider computer 700 communicates over the internet 702 with a personal computer 702 on the client side, for example a laptop computer, to which is installed an interface as described herein.

On the service provider side, is situated a wire data service 703 which provides a stream of real time data over communications network 702 to the client side 701. The client computer 701 comprises a data modem 704, a visualization component 705, a user interface 706 comprising a key board 707 for entry of key strokes, and a pointing device 708, for example a mouse or track ball device, and a screen display 709.

The visualization component may be provided as a downloadable set of program code instructions which can be delivered on a data storage media such as a CD-ROM, or which can be downloaded over the internet from the service provider for installation on the personal computer.

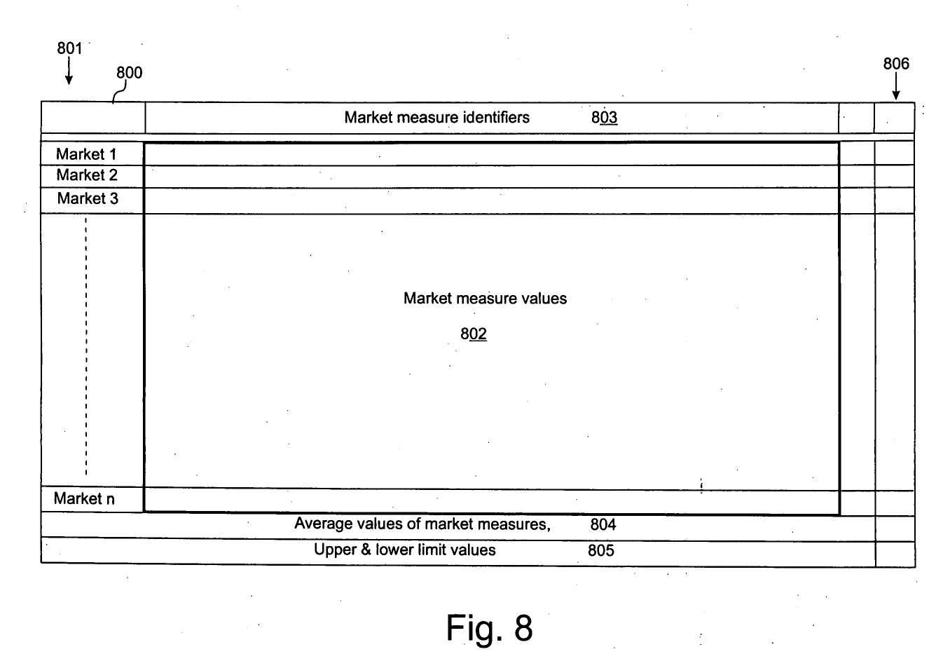

Referring to FIG. 8 herein, there is illustrated schematically a layout of a first screen display view of a first display interface according to a fifth specific embodiment, in which each of a plurality of individual markets is represented as a row in a plurality of rows and columns. The display comprises: a first column 801 which lists a plurality of market identifiers, market 1, market 2 . . . etc, each identifying a particular market; a region 802 for displaying a plurality of values of market measures; a market measure display region, first row 803 which lists a plurality of market measures, each market measure heading a column in the market value region in which corresponding respective market measure values are displayed for each market identifier; an average value display region, second row 804 containing a set of average values of market measures, wherein each average value is aligned with its corresponding respective column of market measure values; a limit display region, third row 805 for displaying upper and lower limit values of market measures; and a generic market parameter display region column 806 for displaying a plurality of generic market measure parameters, in a manner such that a plurality of generic market measures are displayed in a single column and can be visually compared with each other.

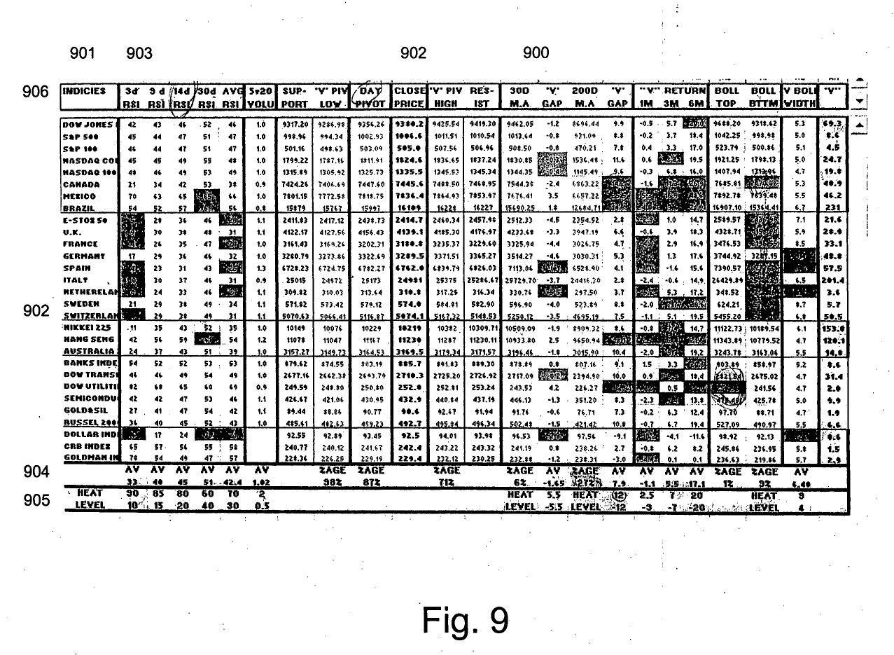

Referring to FIG. 9 herein, there is illustrated schematically an instance of a screen view of a market display of FIG. 8 herein, comprising a plurality of rows and 1-42 and columns A-Z, AA-AH.

An active area 900 of the screen displays a set of values which are received from the service provider computer in real time. In a first column 901, each row is designated with a market identifier data describing a particular market. In the example shown, the market identifier data describing the market comprises the name of the market, for example “Dow Jones”; “Standard and Poors 500”; “Standard and Poors 100”; “NASDAQ 100”.

In a market values region 902, each column represents a measure which is applicable to a market. For example in the numbers which appear in first column 903 represent the values of the three day RSI indicator for the indices indicated in first column 901. In the market value region, at the intersection between each column and each row, a value may be displayed corresponding to the value of the market measure for the market identifier corresponding to that row. For example at the intersection between row 1 Dow Jones of the market value region, a first column of the market value region (three day RSI), the three day RSI measure for the Dow Jones index is at a value of 42.

A further row 904 contains a set of average values, one for each market measure column B-Z, M-AG respectively. The average value represents the average of all the individual market indicator values for a particular market measure across a plurality of markets represented by the plurality of rows. For example, the third column of the market value region, containing values for the nine day RSI indicator for a plurality of markets, is averaged at the intersection between the third column and the average value row 804, giving an average value of 40 for the plurality of nine day RSI indicators down the third column. Similarly, for each column of values, representing values of the particular market measure over a plurality of markets, the average of those values appears in the corresponding column of the average value row. This enables a comparison of each value for a particular market measure, against an average value of individual market measure values for each of a range of different markets.

In some instances, the average value may be represented as a percentage.

Individual functionality of the screen display and interface of FIGS. 8 and 9, as provided by the visualization components, will now be described.

Generic Market Measure—“V” Parameter

The generic market measure “V” incorporates both a backward looking calculation, and a forward looking calculation implied by an option.

A prior art understanding of volatility is exemplified in “Option Volatility and Pricing Strategies” by Sheldon Natenberg; Probus Publishing, ISBN 1-55738-009-0, chapter 4. The “V” parameter is not strictly a measure of volatility as is known in the prior art.

In the present embodiments, the “V” measure comprises three components:
1. Backward looking volatility.
2. Forward looking volatility.
3. Observed current volatility.

The “V” measure is a metric which normalises variations in change of market value for all market measures across the whole of the display screen, enabling a common comparison between markets to be made, so that a plurality of different markets can be compared using the same “V” parameter calculated respectively for each market.

Calculation of the V Parameter

The V parameter can be determined by the following method:
Observe 30 day volatility of a market;
Determine the implied daily movement from the backward looking volatility of the market (this known measure is available from Bloomberg data);
Determine the implied daily movement from forward looking 30 day volatility for the market (this known measure is also available from Bloomberg data);
Determine the average trading range, which includes gap openings;
Take a straightforward mean average of the above three measures.

Upper and Lower Limit Values (Heat Levels)

The upper and lower limit values (heat levels) displayed and set in limit display region 705 can be set to any value which a user requires, and depending upon the user's own view of what constitutes an unusual movement in a particular market to which the “heat level” indicators apply. They therefore provide a useful tool which can be refined with experience of the user. The user can set the levels using experience and intuition, to a value beyond which the user considers that movements outside those values constitute a significant market movement.

Highlighting of Market Values

The visualization component continually monitors each market value, and compares it against the upper and lower limits which have been set by the operator for that market value.

Various levels of highlighting may be applied, which in the best mode herein may be presented as different color codings. For example, different highlighted colors may be assigned as follows:
red—denotes an extreme movement relative to the upper/lower limits (heat levels) set;
orange—denotes a significant shift in the market value compared to the upper and/or lower limits (heat levels);
yellow—denotes a moderate, movement of the market value compared to the upper and lower limits;
white—denotes no significant variation in the market value compared to the upper and lower limits.

The highlighting feature is determined by the individual user's pre selection of individual technical indicators, so for example, the highlight feature can be set to activate at a limit level of above 70, or it can be configured to activate at a highlight level of above, for example 80. The highlight feature may be pre-settable by a user in either the embodiment data processing and display system of FIG. 6, via a web interface in which case a server side program is instructed to set the highlight feature, or in the embodiment of FIG. 7, in which case highlight setting is made on the client side by a client side application. The user can select when and under what circumstances a particular technical indicator (value indicator) will activate.

In one mode of operation, the visualization component continuously monitors the stream of data of each individual market value. For a particular market value, a comparison is made between the instantaneous value of that market value and the upper limit for that value which has been pre-set by the user. If the instantaneous value of the market value is higher than the preset limit, a highlight signal is generated which overlays the display of that value on the screen. For example, the highlight may consist of a coloring, for example coloring red, to indicate that the value has exceeded an upper pre-set limit. However, if the instantaneous value is below the pre-set upper limit, any highlights which are already applied are removed from the display of that value. The visualization component may compare the instantaneous market value with the pre-set lower limit for that market value. If the instantaneous value is below or equal to the pre-set value, the visualization component may generate the highlight feature, representing the fact that the market value has gone below the lower limit. However, if the instantaneous value is above the lower limit, that is, it is below the upper pre-set limit and above the lower pre-set limit, any pre-existing highlighting may be removed.

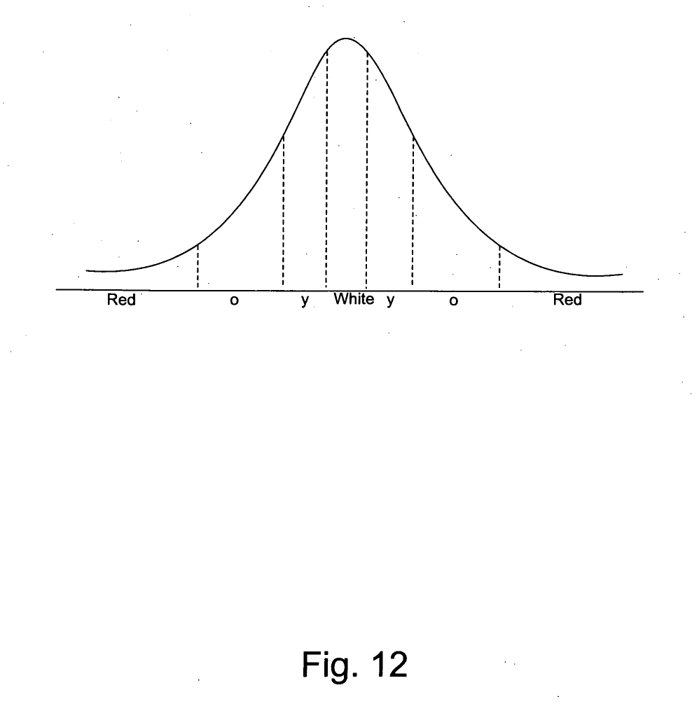

In another mode of operation, the visualization component may apply a banding of different colors according to a statistical distribution, as shown In FIG. 12 herein. In that case, the visualization component compares the instantaneous market value with a statistical distribution of that market measure, and generates a cover signal depending upon the extent of variation of that value of market measure away from the center (mean or medium) of the distribution. The distribution may be compiled as a result of a varying time window of real time data. For example, the user (or the service provider) may select a distribution determined from 30 days worth of historical data, 60 days, or 90 days of historical data, or any other period, at the user or service provider's option.

The screen view provides a data display method for displaying market data in which value data is displayed which describes values of a plurality of markets on a single screen view and which highlights any markets which exhibit movements in their value which are abnormal relative to movements in values of a whole portfolio of markets displayed on the single screen view. Any unusual behaviour of a market relative to the behaviour of an overall group of markets selected for display on the screen can be highlighted, and referenced to a user's own parameters as set by the limit level.

Using the highlighting feature, if a user is indifferent as to what specific speculation or trading action to take at any time, they can immediately see from the highlight feature where any significant movements to markets is occurring referenced to their own limits of market movement which they can set themselves and reference to their own selection of markets viewed on a single screen. This can be achieved across a whole spectrum of traded financial products and/or instruments for which online data is available, relatively quickly in a single view.

Configuration of Displays

In a further embodiment, a service provider may configure the displays which are served from the service provider server computer and made available to the client computer into a predetermined format, with the object of providing different service levels corresponding to different screen formats.

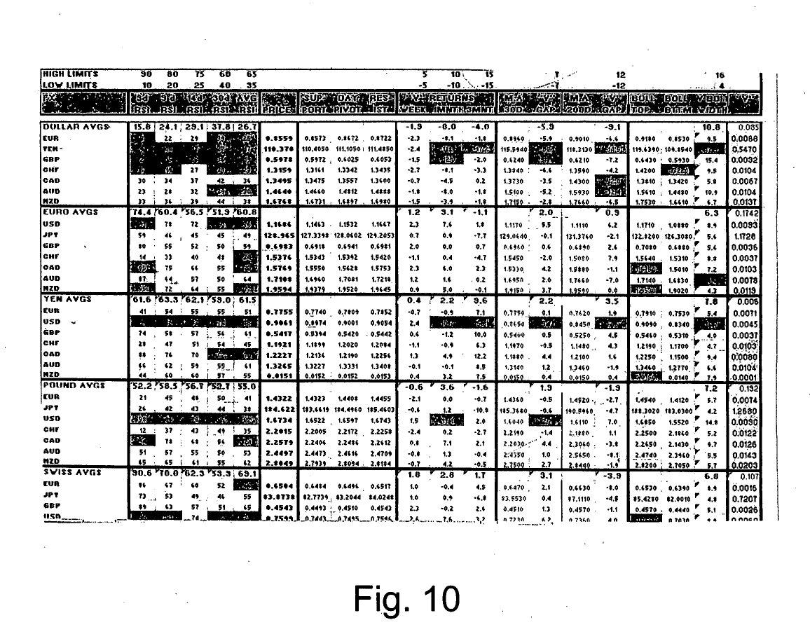

Referring to FIG. 10 herein, there is illustrated schematically a second instance of a screen view of the first display interface of FIG. 8, showing a different arrangement of market data.

For example, the service provider may configure a default screen having a layout as shown in FIG. 10 herein showing dollar averages, Euro averages, yen averages and pound averages, these being four of the major currencies traded, and having three day, nine day, fourteen day, thirty day and average RSI indicators, price measures, support measures, day pivot measures, resistance level measures, “V” returns weekly, monthly and three monthly, thirty day moving average, “V” measure gap, 200 day moving average, and “V” gap for 200 day average; and a “V” measure for each market. Such a screen may be provided as a default view at a first level of service. At a second level of service, user configurability may be provided to the default screen, whereby a user can substitute individual markets from a selection of markets provided in a fixed menu provided by the service provider. Further, the individual market measures may be substituted according to a fixed menu provided by the service provider. The number and variations of menu items may be arranged into packages, each package being independently priced as a particular level of service. Further, an amount of configurability of the highlighting effects relative to a median market measure may be provided in discrete packages corresponding to different levels of service, and therefore different pricing levels by the service provider.

It will be appreciated by the skilled person that the arrangement of the columns described with reference to FIGS. 9 and 10 herein may be varied, and in some embodiments the columns may be user configurable. For example, columns may be dragged and dropped so as to rearrange the order of columns presented from left to right along a screen display.

Visualization of Market Movements

By presenting a plurality of market indicators for a range of a plurality of markets on a single screen view, and by applying highlighting to individual market values, whenever those market values reach pre-determined limit levels, a user can be alerted to levels of activity immediately, in a single view.

Referring to FIG. 10 herein, and particularly the column for the 200 day moving average, yen against the Euro, US dollar, pound, CHF, Canadian dollar and New Zealand dollar, the individual market values shown in the 200 day moving average column may all appear in the same color, for example the color light blue, whereas the 200 day moving average for the yen against the Australian dollar may appear in the color red in this example.

The denotes that there is a prima facie bull market in the yen. If, for example, for the 30 day moving average for the yen against Euro, US dollar, pound, CHF, Canadian dollar and New Zealand dollar, all the market values are colored red, this may suggest a prima facie bear market for the yen.

The differences between the primary bear market identified by the 30 day moving average and the primary bull market identified in the 200 day moving average may be resolved by referring to the “V” parameter which constitutes a measure of current, backward looking and forward looking volatility. In the example shown, the “V” gap measure against the column “yen avgs”, in this case having the values of 2.2 and 3.5 respectively for the 30 day and 200 day moving averages are both colored blue, confirming that although to 30 day moving average denotes a short-term primary bear market, overall the long term diagnosis of the market is a primary bull market.

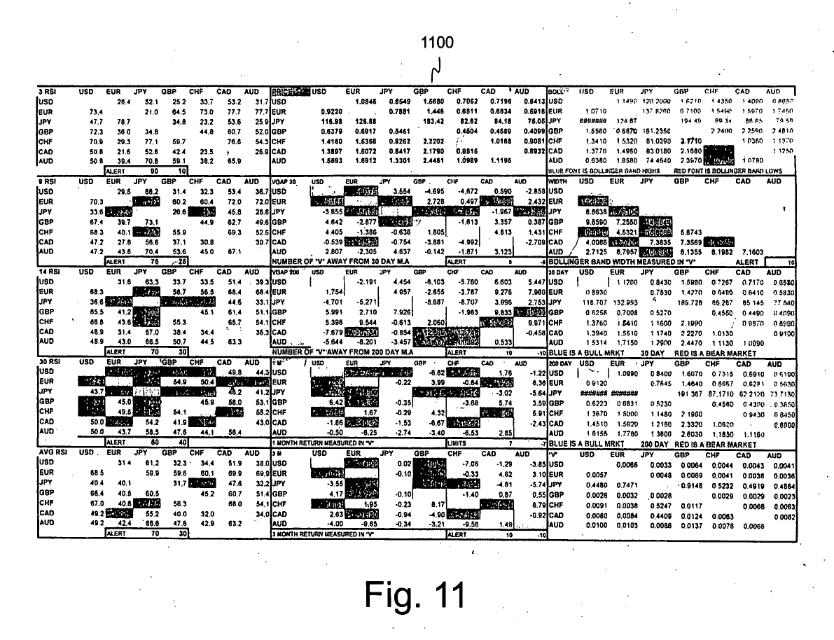

Referring to FIG. 11 herein, there is illustrated schematically a second alternative display layout according to a sixth specific embodiment. In this case, a plurality of two dimensional areas are displayed, for displaying market measures such as (reading downwards, left to right), three day RSI indicator; 9 day RSI indicator; 14 day RSI indicator; 30 day RSI indicator; average RSI indicator; price; number of “V” away from 30 day moving average; number of “V” away from 200 day moving average; one month return measured in “V”; Bollinger band highs; Bollinger bandwidth measured in “V”; 30 day moving average; 200 day moving average; and “V” parameter.

Within each region, which corresponds to a particular market measure, there are arranged in rows and columns individual contracts or financial products, such as US dollar, Euro, yen, etc. An individual market is denoted as an intersection of a row and column within a region. For example, taking the central region 1100 in FIG. 11 an intersect of the US dollar column and the Euro column gives the number of US dollars per Euro as 0.9220. Similarly, the intersection of the Euro column against the US dollar row gives the number of Eurasia per US dollar as 1.846, this being the market value of US dollars per Euro.

Each region may optionally contain an alert level indicator. For example, in the 3-day RSI window, alert levels of 90 and 10 have been specified. The alert levels may be user settable.

Programming of the User Interface Display

Bloomberg currently provide a data service known as APR, and DDE server which sends raw market data across a communications network. However the raw data need not be provided by the Bloomberg service, but could be provided by other service providers such as CQG or Reuters Data Systems. In basic embodiments of the novel user interface displays described herein, the displays may be constructed in Microsoft Excel®. Further, the interface may be programmed in other known spreadsheet packages, or constructed in known computer programs, programmed to be user definable via the display interface to suit each individual user of the system, and/or may be preset by a service provider to provide a predetermined method by which the V parameter is calculated.

Where the market measures are provided in a market measure region in the form of a title bar 906, the average values are provided in an average bar 904, along a row, and heat levels are provided in an heat level bar 905, the skilled person will appreciate that the order of the title bar 906, average bar 904, and heat level bar 905 and the market value matrix 902 may be interchanged. In some embodiments, the title bar, average bar, and heat level bar may be dragged and dropped in any order, and may even be placed so as to split the market value matrix region 902. Such features may be user configurable in some embodiments, or in other embodiments, a service provider may provide a preset display format comprising the aforementioned elements.

Referring to FIG. 11 herein, there is illustrated schematically a further example of a user interface, configured for displaying data representing a set of currency markets. Each market is represented by a row, and individual market measures are represented as a set of columns which intersect the plurality of rows.

A plurality of currency markets across the world are displayed in a single screen view. Individual market measures which have values which are outside pre-set limits are highlighted. In the example shown, considering the dollar verses yen market (equivalent to the yen verses dollar market), this market can be clearly seen to be very active, since the three day, nine day, fourteen day, and thirty day RSI measures and the average RSI are all highlighted in a first color for both the dollar/yen and the yen/dollar market. Further, the column headed “V” returns for one month and three month, and the thirty day moving average “V” gap as well as the two hundred day moving average “V” gap are also highlighted in red, indicating that there is a significant amount of movement in the dollar/yen and yen/dollar markets.

Further, in the example shown in FIG. 11, the amount of highlighting in the dollar/euro, dollar/Swiss franc, dollar/sterling markets, together with their corresponding markets euro/dollar, sterling/dollar, Swiss franc/dollar counterparts are all colored in red, indicating that the dollar itself is making significant movement against a range of currencies including the euro, Japanese yen, sterling, and Swiss franc.

Because these markets are highlighted and are all presented in the same screen display where the highlighting feature is based upon the generic “V” parameter, a human user can gain the information at a glance, that relative to other currency markets, the dollar/yen (yen/dollar) market is very active relative to other currency markets, and can interpret this activity as being a net capital flow representing transfer of large amounts of capital from dollars to yens, or vice versa from yens to dollars. The human user is therefore alerted visually to significant capital flows across world currency markets, and can interpret such information within a matter of a short time scale, i.e. on a timescale of one second or less upon viewing the screen display.

This may enable users to be alerted to movements which would otherwise be missed. For example, many traders will be looking at major currencies such as the yen and the dollar and the trading relationship between those two currencies. However, movements between the New Zealand dollar and the South African dollar for example may not be regularly analyzed by many traders. Using the screen display as shown in the specific embodiments herein, if there are significant movements in an obscure market, for example New Zealand dollar/South African dollar market, these will be highlighted in an eye catching color, such as red, on the screen to alert the users attention to the unusual level of activity to that market.

Whilst conventional trading screens use the color red to denote that a financial instrument is down on the day, i.e. trading below the days opening price, and a blue color to denote that an instrument is up on the day, i.e. trading above its opening price, in the specific embodiments herein, the colors red and blue may be used to reference longer term trends taken over a period of time extending more than one day.

Referring to FIG. 12 herein, color codings may be assigned to areas of a statistical distribution such as a log normal or Gaussian distribution, where upper and lower limits may be set either side of a median value of the log normal or Gaussian distribution. For example, white coloring may be applied at a peak of the distribution, moving outwardly from the center of the distribution, both above and below the median, the next color band of yellow may be activated. Either side of the yellow bands the orange color may be activated, and the red color may be applied at the extremities of the distribution.

The range of the distribution over which the different colorings are applied can be set by the user, and the number of color bandings which apply can also be set by the user.

Portfolio Assessment

Historically, it is known for investors managers and speculators to measure an overall risk of a portfolio of financial interests. The specific embodiments described herein allow a novel way of measuring a portfolio of financial interests assessed using a trend analysis based on the “V” parameter. An overall measure of the proportion of individual “V” parameters which are in-trend, compared to the number of overall individual “V” parameters which are against-trend.

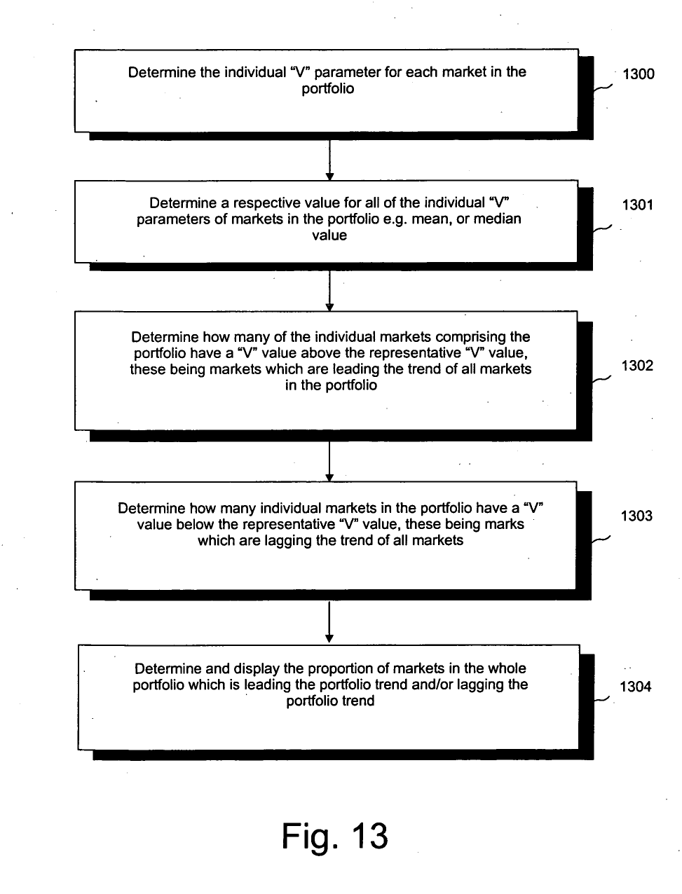

Referring to FIG. 13 herein, there is illustrated schematically process steps carried out by the visualization component for determining an overall trend measure of a portfolio of markets displayed on screen.

Such a measure may be determined by the following method:
Determine the individual “V” parameter for each market in the portfolio;
Determine a representative value for all of the individual “V” parameters of the plurality of markets in the portfolio, for example this may be a mean, or a median value;
Determine how many of the individual markets comprising the portfolio have a “V” value above the representative “V” value, these being markets which are leading the trend of all markets in the portfolio;
Determine how many individual markets in the portfolio have a “V” value below the representative “V” value, these being markets which are lagging the trend of all markets;
Determine and display a composite index describing the proportion of markets in the whole portfolio which is leading the portfolio trend and/or lagging the portfolio trend. The composite index is an index of a plurality of technical indicators, i.e. of the “V” parameters.

For example, the proportion of the portfolio leading/lagging the trend may be 70/30 indicating that 70% of the portfolio is on-trend, whereas 30% of the portfolio is against the average portfolio trend.

Expressed mathematically, a composite index of the proportion of market indicators within a trend T_{lead} may be expressed

$${T}_{lead} = \frac{{N ( V )}_{a}}{{N ( V )}_{p}} \times 100 \% \qquad ( 1 )$$

Where N(V)ₐ is the number of markets having a “V” parameter which is above the average V parameter for the whole portfolio, and N(V)ₚ is the number of markets within the portfolio for which an individual V parameter is determined.

Similarly, the composite index of the proportion of markets in the portfolio which lag the market movement trend may be expressed as:

$${T}_{lag} = \frac{{N ( V )}_{b}}{{N ( V )}_{p}} \times 100 \% \qquad ( 2 )$$

Where N(V)_{b} is the number of markets which have a V parameter which is below the average V parameter for the whole portfolio.

The composite index display T_{lead} represents a proportion of markets of a group of markets displayed which are within a trend. The composite index display T_{lag} displays a proportion of markets which are outside a trend.

Supposing a user has various different stocks or instruments in their portfolio each represented by a different market and displayed in a single view, they may be weighted in different ways and there may be provided according to the embodiments, methods and services described herein, a single composite index representing technical analysis indicator, displayed in a single screen view to the user. For example a composite technical analysis indicator T_{lead}:T_{lag} may be applied, giving an 80:20 result, indicating that 80% of the displayed markets are leading the trend, and 20% are lagging the trend, or in another instance a 27:73 value of composite technical indicator index, representing that 27% of the displayed selection of markets are leading the overall trend for all markets displayed, and 73% are lagging it.

The above composite measure may be implemented as a set of program code instructions. In one embodiment, the program may comprise a component for determining an individual “V” normalizing parameter for each market said normalizing parameter being a parameter which is determined from a set of volatility measurements of said market; a component for determining a representative value for all of the individual normalizing parameters, for each said market; a component for determining how many of the individual markets comprising the portfolio have a normalizing parameter value above the representative value, these being markets which are leading the trend of all markets in the portfolio; a component for determining how many of the individual markets have a normalizing parameter value below the representative value, these being markets which are lagging the trend of all markets in the portfolio; and a component for determining and displaying the proportion of the whole portfolio which is leading or lagging the portfolio trend.

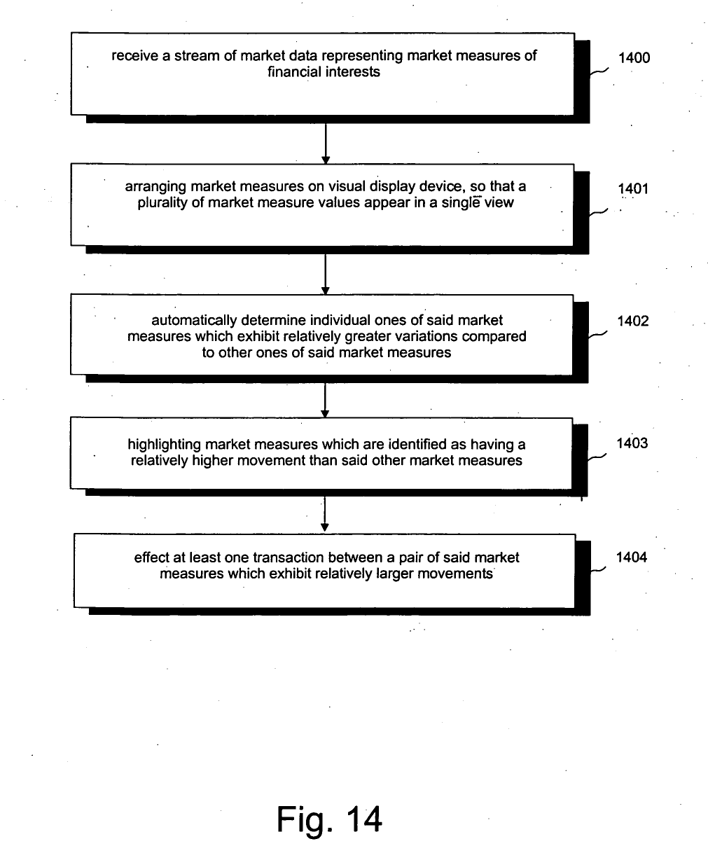

Referring to FIG. 14 herein, there is illustrated schematically process steps carried out using the display and trading systems described herein for effecting a market trade. Streams of market data are continuously received in real time representing values of market measures of a wide range of financial interests, and are input into the visualization component in ongoing process 1400. The market measures and values of individual contracts, commodities etc comprising the markets are arranged on a visual display device as described with reference to FIGS. 8 to 11 herein, so that a plurality of market measures appear in a single view on a single screen (1401). As an ongoing background operation, individual values of market measures are compared with upper and lower “heat level” limits, and a normalizing parameter “V” is continuously calculated for each market. Any market measures which exhibit relatively greater variations compared to other ones of market measures are identified in process 1402 by an analysis of their great levels, that is, how close they are to a mid value of a statistical distribution of historically collected values for that market in process 1402. In process 1403, and market measures which are identified as having significant movement away from a normal behavior are highlighted in a manner as described here and before. In process 1404, after having viewed a plurality of markets on a single screen, in which individual markets which are showing significant movement are automatically highlighted, a trader, broker or other user of the system can affect a trade between a pair of market measures which have been highlighted.

Online Service Provision

Referring again to FIGS. 5 and 6 herein in particular, and to the other embodiments and methods described herein, the features referred to may be provided as an online service accessible over the internet or over a virtual private network or intranet, using a web browser or other similar interface. An online electronically deliverable service may comprise providing a remotely accessible visual display interface comprising, a plurality of market indicators, each indicating a corresponding respective market a plurality of value indicators, extending over said plurality of markets; indicating values for a plurality of market measures in real time; and at least one user settable limit value, representing a limit value of a said value indicator, wherein said display is operable for highlighting any individual said value indicator which exhibits a predetermined level of activity in relation to a said limit value.

The online service may comprise calculating for each of a plurality of said markets a generic market indicator which allows each said displayed market to be compared with each other displayed said market. A composite indicator for indicating a technical analysis measure of a portfolio of markets as described above may be calculated at a server computer and delivered online over a network to client computer for display in a single screen view. Markets which exhibit movements in their value which are abnormal relative to movements in values of a whole portfolio of markets may be displayed on said single screen view at the client computer.

Specific embodiments of the present invention may have an advantage that a human user can view data spanning a plurality of different markets on a single screen, and may set upper and lower limits of variation of market values for any particular market. When a value indicator of a market exceeds the predetermined upper or lower threshold limits, the market value may be highlighted to provide an alert signal to the user. Various levels of highlights may be applied, for example by applying different colors around a market value which has approached or exceeded a pre-set limit, to indicate various levels of alert.

Specific embodiments described herein may allow a trader to visualize changes between different markets, on a single screen view, and thereby enable a human being to identify capital flows from one market to another, since such capital flows may appear highlighted in an obvious manner which may immediately attract the attention of the human user.

Specific embodiments and methods disclosed herein may provide an individual user with a single screen summary which automatically in real time indicates areas of significant activity across a wide range of diverse markets. This information may be used by traders in a financial institution to supplement the advice given at morning meetings by in house economist teams, and for identifying opportunities for trades across markets.

For traders who do not have access to regular economist opinion, the specific embodiments, methods and services disclosed herein can enable these users to gain a visual summary of market movements and capital flows of overnight price movements, color coded in a concise screen view.

A trader or investor may be able to make their own substantially instantaneous assessment of markets by viewing the screen display across a plurality of markets, in a much quicker time and in a more intuitive way, than by reading and analysing lengthy and voluminous economist's or stock analyst's reports. Market areas highlighted by the screen may draw a trader or investor's attention to particular markets, following which the trader or investor may refer to their economist or analyst to gain an explanation of the movement prior to effecting a trade or series of trades. This applies for currencies, commodities, equities, fixed interest markets, and any other market for which real time electronic price and/volume data is available. Highlighting of markets is based on technical indicators rather than absolute value based.

1. A visual display comprising:
a plurality of market indicators, each indicating a corresponding respective market
a plurality of value indicators, extending over said plurality of markets; indicating values for a plurality of market measures in real time; and
at least one user settable limit value, representing a limit value of a said value indicator; wherein
said display is operable for highlighting any individual said value indicator which exhibits a predetermined level of activity in relation to a said limit value.

2. The visual display as claimed in claim 1, operable for displaying a plurality of highlight features, each highlight feature representing a different level of activity in a said market indicator.

3. The visual display as claimed in claim 1, wherein said individual value indicators are configured to be pre selectable by a user, such that said highlighting applies to at least one pre-selected value indicator.

4. The visual display as claimed in claim 1, wherein said highlighting feature is activated when a said limit value of at least one pre selected technical value indicator is reached.

5. The visual display as claimed in claim 1, wherein said highlight feature is operable for highlighting an individual said market based upon a comparison of said value indicator with a statistical distribution of values of a said market measure.

6. The visual display as claimed in claim 1, wherein each said market measure has assigned to it at least one corresponding respective user settable limit value.

7. The visual display as claimed in claim 1, wherein a said plurality of values applicable to a plurality of different markets are displayed at the same time in a single display view, on a single screen.

8. The visual display as claimed in claim 1, comprising a composite index representing a plurality of technical indicators.

9. The visual display as claimed in claim 1, comprising a display parameter representing a proportion of markets of a group of markets displayed which are within a trend.

10. The visual display as claimed in claim 1, comprising a display parameter representing a proportion of markets of a group of markets displayed which are outside a trend.

11. The visual display as claimed in claim 1, comprising a composite indicator indicating an technical analysis measure of a portfolio of markets displayed in a single screen view.

12. An electronic data carrier containing program means for generating a visual display, said program means comprising:
means for generating a plurality of market indicators, each indicating a corresponding respective market;
means for generating a plurality of value indicators extending over a plurality of markets, indicating values for a plurality of market measures in real time;
means for setting at least one user settable limit value representing a limit value of a said value indicator; and
means for generating a highlight display, for highlighting any individual said value indicator under conditions when a value of said market measure exceeds a pre-determined level.

13. A visual interface comprising:
a plurality of market indicators, representing a plurality of different markets;
said plurality of market indicators being arranged within a single view, such that said plurality of market indicators can be viewed at the same time on a single screen; and
a set of user adjustable limits, operable for setting range limits for said plurality of market indicators;
wherein said interface is operable for automatically highlighting individual said market indicators, when said market indicators reach a pre-determined relationship compared to said range limits.

14. A method of operating a visual interface comprising:
generating a plurality of market indicators representing a plurality of different markets;
arranging said plurality of market indicators within a single view such that said plurality of market indicators can be viewed at the same time on a single display screen;
generating a set of user adjustable limits representing upper and lower limits for each of said plurality market indicators; and
when individual ones of said market indicators exceed said upper or lower limits, automatically highlighting said displayed individual market indicators on said single screen view.

15. A data carrier comprising program means for generating a visual display comprising:
a program component for generating a plurality of market indicators representing a plurality of different markets;
a component for arranging said plurality of market indicators within a single view such that said plurality of market indicators can be viewed at the same time on a single display screen;
a component for generating a set of user adjustable limits representing upper and lower limits for each of said plurality market indicators; and
a component for automatically highlighting individual ones of said market indicators which exceed said upper or lower limits.

16. A data display comprising:
a market indicator region for displaying a set of market indicators describing individual markets;
a market measure display region configured to display in real time a set of values of one or more market measures;
a limit display region for setting upper and lower limits on values of a said market measure;
wherein said display is operable for highlighting any individual market data under conditions where a value of a said market indicator exceeds said upper or lower limit values.

17. A method of displaying data representing a plurality of markets, said method comprising:
displaying in real time a set of values of at least one market measure;
displaying a set of market indicators each describing individual said market;
displaying a limit region comprising upper and lower limit displays representing limits on values of a said at least one market measure;
highlighting any individual market data which has a value which exceeds said upper and lower limit values displayed in said corresponding respective limit region.

18. A method of measuring trends in a portfolio of financial interests, said method comprising:
determining an individual “V” normalizing parameter for each market said normalizing parameter being a parameter which is determined from a set of volatility measurements of said market;
determining a representative value for all of the individual normalizing parameters, for each said market;
determining how many of the individual markets comprising the portfolio have a normalizing parameter value above the representative value, these being markets which are leading the trend of all markets in the portfolio;
determining how many of the individual markets have a normalizing parameter value below the representative value, these being markets which are lagging the trend of all markets in the portfolio;
determining and displaying the proportion of the whole portfolio which is leading or lagging the portfolio trend.

19. A data carrier carrying program code instructions for a computer program capable of measuring trends in a portfolio of financial interests, said program comprising:
a component for determining an individual “V” normalizing parameter for each market said normalizing parameter being a parameter which is determined from a set of volatility measurements of said market;
a component for determining a representative value for all of the individual normalizing parameters, for each said market;
a component for determining how many of the individual markets comprising the portfolio have a normalizing parameter value above the representative value, these being markets which are leading the trend of all markets in the portfolio;
a component for determining how many of the individual markets have a normalizing parameter value below the representative value, these being markets which are lagging the trend of all markets in the portfolio; and
a component for determining and displaying the proportion of the whole portfolio which is leading or lagging the portfolio trend.

20. A method of trading financial interests, said method comprising:
providing via a computer network, a stream of market data representing market measures of a plurality of financial interests;
arranging said plurality of market measures on a visual display device, such that said plurality of market measures appear in a single view;
automatically determining individual ones of said market measures which exhibit relatively greater variations in value compared to other ones of said market measures;
highlighting said market measures which are identified as having a relatively higher movement than said other market measures; and
effecting at least one transaction between a pair of said markets having market measures which exhibit relatively larger movements.

21. A method of determining a normalizing parameter by which a plurality of markets may be compared with each other, said method comprising:
for each said market:
obtaining a backward looking volatility data;
obtaining a forward looking volatility data;
obtaining a current volatility data;
combining said backward looking, forward looking and current volatility data to obtain said normalizing parameter.

22. The method as claimed in claim 21, wherein said step of combination comprises:
determining an average of said backward looking volatility data, said forward looking volatility data, and said current volatility data.

23. The method as claimed in claim 21, wherein said step of combination comprises:
determining a weighted of said backward looking volatility data, said forward looking volatility data, and said current volatility data.

24. A data display method for displaying market data comprising:
displaying value data describing values of a plurality of markets on a single screen view;
highlighting any markets which exhibit movements in their value which are abnormal relative to movements in values of a whole portfolio of markets displayed on said single screen view.

25. A data display for displaying market data of a plurality of selected markets, said display comprising:
a value display region for displaying data describing values of a plurality of said markets on a single screen view; and
a composite technical analysis parameter representing an overall measure of a plurality of individual technical analysis parameters for each of a respective plurality of markets selected in a single display view.

26. A composite technical analysis parameter representing an overall measure of a plurality of individual technical analysis parameters for each of a respective plurality of markets selected in a single display view.

27. The composite technical analysis parameter as claimed in claim 26, comprising a measure of a proportion of markets leading an overall market trend and a proportion of markets lagging an overall market trend.

28. An online electronically deliverable service comprising:
providing a remotely accessible visual display interface comprising:
a plurality of market indicators, each indicating a corresponding respective market
a plurality of value indicators, extending over said plurality of markets; indicating values for a plurality of market measures in real time; and
at least one user settable limit value, representing a limit value of a said value indicator; wherein
said display is operable for highlighting any individual said value indicator which exhibits a predetermined level of activity in relation to a said limit value.

29. The online service as claimed in claim 28, comprising:
calculating for each of a plurality of said markets a generic market indicator which allows each said displayed market to be compared with each other displayed said market.

30. The online service as claimed in claim 28, further comprising:
providing a composite indicator for indicating a technical analysis measure of a portfolio of markets displayed in a single screen view.

31. The online service as claimed in claim 28, comprising:
highlighting any markets which exhibit movements in their value which are abnormal relative to movements in values of a whole portfolio of markets displayed on said single screen view.
